(19) United States
(12) Patent Application Publication
(10) Pub. No.: US 2008/0023445 A1
(43) Pub. Date: Jan. 31, 2008

(54) Switching Contfact for Vacuum Interrupters

(76) Inventors: Wilfried Haas, Erlangen (DE); Werner Hartmann, Weisendorf (DE); Michael Romheld, Uttenreuth (DE)

Correspondence Address: HARNESS, DICKEY & PIERCE, P.L.C., P.O.BOX 8910, RESTON, VA, 20195, US

(21) Appl. No.: 11/631,257

(22) PCT Filed: Jun. 23, 2005
(86) PCT No.: PCT/EP05/52949

§ 371 Date: Dec. 29, 2006

(30) Foreign Application Priority Data
Jun. 30, 2004 (DE) 102004031887.5

(51) Int. Cl. H01H 33/664

(52) U.S. Cl. 218/141

(57) ABSTRACT

A switching contact is disclosed for vacuum interrupters, having a radial or axial magnetic field. In at least one embodiment, the switching contact includes a switching contact carrier and a contact plate. The switching contact carrier contains a coil for generating a magnetic field, said coil being formed by slitting the wall of a pot-like contact carrier. The outer diameter of the slitted wall of the pot-like carrier is smaller than the diameter of the contact plate located thereon. The switching contact is also provided with an annular supporting body which is inserted between the contact plate and the base of the contact carrier and surrounds the contact carrier at least in the slitted region. A vacuum gap is provided between the outer supporting body and the slitted wall.

### PRIORITY STATEMENT

This application is the national phase under 35 U.S.C. § 371 of PCT International Application No. PCT/EP2005/052949 which has an International filing date of Jun. 23, 2005, which designated the United States of America and which claims priority on German Patent Application number 10 2004 031 887.5 filed Jun. 30, 2004, the entire contents of which are hereby incorporated herein by reference.

### FIELD

Embodiments of the invention generally relate to a switching contact for vacuum interrupters.

### BACKGROUND

Switching contacts for vacuum interrupters, which include a switching contact carrier and a contact plate, are known from the prior art. The switching contact carrier contains a coil segment for generating a magnetic field, which is formed by azimuthally slitting the lateral circumference of a cup-shaped contact carrier. Such contact arrangements are described particularly in EP 0 104 384 B1 and EP 0 155 376 B1.

Depending on the orientation of the two switching contacts with respect to each other, either a radial or an axial magnetic field is generated, such arrangements with an axial magnetic field being important in practice particularly for high voltages. For the axial magnetic field, the slits of the contact carrier are oriented in the same sense in both contacts.

After breaking processes of short-circuit currents in conventional contact forms, especially AMF (Axial Magnetic Field) contacts in the medium- and high-voltage range exhibit pronounced expansions of the slitted coil segments in the radial direction, so that increased electric fields occur at the edges of these coil segments and this accordingly deteriorates the dielectric properties of the interrupters significantly.

In order to ensure stability of the contact arrangement even with high currents and voltages, support bodies made of high-temperature resistant steels are also already provided in the prior art. These contact bodies, however, are arranged exclusively inside the contact cup.

DE 93 05 125 U1 has already disclosed such a vacuum switching contact, in which an outer sleeve is used for the latter purpose. The object however is therefore likewise to increase the stability of the contact. Furthermore, DE 33 02 939 A1 describes a vacuum switching chamber with contacts, in which an arrangement with coil segments is arranged centrally in the contact, and an annular gap with an at least partially extending web is arranged around this. This arrangement serves exclusively to increase stability.

### SUMMARY

In at least one embodiment of the invention, switching contacts are provided with increased performance.

In the switching contact according to at least one embodiment of the invention, the outer diameter of the slitted cup wall is less than the diameter of the contact plate lying thereon. There is also an annular support body which is inserted between the contact plate and the base of the contact carrier and encloses the contact carrier at least in the slitted region. Between the outer support body and the slitted cup wall, there is a free gap which forms a vacuum gap when used as intended in the vacuum interrupter.

At least one embodiment of the invention provides an improved switching contact, which is usable particularly in vacuum interrupters with an axial magnetic field, the field strengths occurring at the slit edges of the cup wall being minimized. No suitable solution for the problem of perturbing electric fields is known from the prior art. Specifically, if the coil former is held by an externally circumferential steel band as a sleeve according to DE 93 05 125 U1 with only moderate conductivity, then the previous production methods entail a deterioration of the switching capacity typically by approximately 30%, which leads to the vacuum interrupters being much larger and therefore more expensive. The reason for this deterioration of the switching capacity resides in the partial short circuits between two coil segments separated by a slit, due to the steel band, the short circuit being caused by the electrically intimate contact between the steel band and the coil segments, or between two neighboring coil segments, which results from the influx of highly conductive solder during the soldering process.

An AMF contact according to at least one embodiment of the invention with an outer support body is produced by maintaining a distance of typically one millimeter between the outer support body and the coil former during manufacture, and soldering the outer support body to the contact system only in its upper and lower edge regions. This gap width avoids direct bridging of the gap by inflowing solder. If the coil former nevertheless expands by short-circuit breaking in switching operation, then at most an electrical connection with only a low current-carrying capacity and a comparatively high resistance is formed between two coil elements, so that the contact itself experiences only a small reduction in the switching capacity because of electrical shunting by the outer support body. If an outer support body made of an electrically nonconductive material is selected, for example made of ceramic, or if a metallic outer support body is coated with a ceramic material on its inside, then the electrical shunt during expansion of the coil former is entirely obviated and the switching capacity is not then reduced.

Conventional contact designs and sizes can be used, even larger slit angles of the coil former being possible in order to increase the switching capacity based on at least one embodiment of the present invention, since the outer support body has a stabilizing effect on the entire contact system. With an equivalent size, therefore, greater breaking capacities can be achieved than in the prior art.

### BRIEF DESCRIPTION OF THE DRAWINGS

Further details and advantages of the invention will be found in the following description of the figures and example embodiments with the aid of the drawings, in conjunction with the patent claims.

FIG. 1 shows an AMF contact pair according to the prior art in a perspective representation and

FIG. 2 shows a section through a contact according to at least one embodiment of the invention with an outer support body.

### DETAILED DESCRIPTION OF THE EXAMPLE EMBODIMENTS

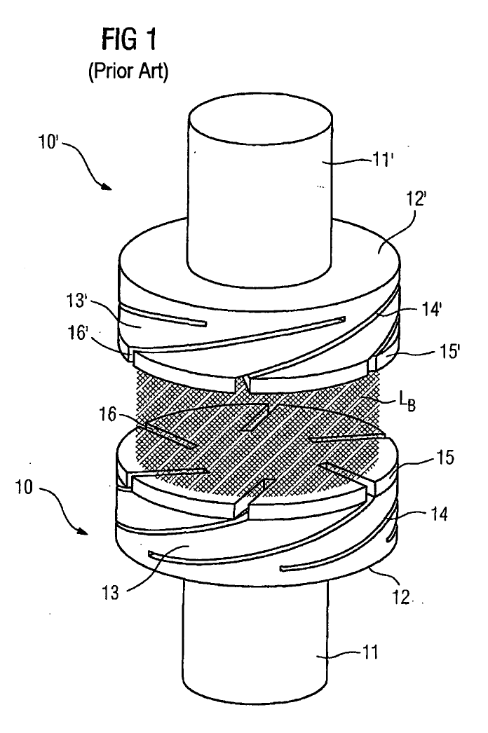

FIG. 1 represents a contact pair arrangement 1 according to the prior art, which consists of two identical contacts 10, 10′. The contacts 10, 10′ respectively include a contact bolt 11, 11′, a contact carrier 12, 12′ and a contact disk 15, 15′.

The contact carrier 12, 12′ in FIG. 1 is designed with a cup shape and has straight or curved, azimuthally inclined slits 14, 14′ on its annular part, which is referred to as the cup wall 13, 13′. These slits 14, 14′ extend over the circumference of the cup wall 13, 13′ from the base, i.e. the cup bottom, to the free end of the cup wall 13, 13′. At the free end of the cup wall 13, 13′, they open into slits 16, 16′ of a contact plate 15, 15′ resting on the contact carrier 12, 12′. The slits 16, 16′ are often directed radially, although they may also make a non-zero angle with the radius.

Such an arrangement is known from the prior art, in respect of which reference is made to the prior art cited in the introduction. The azimuthal slits 14, 14′ in the contact carrier 12, 12′ form coil segments, in which the current to be switched flows. The current to be switched generates a magnetic field which, with the orientation of the slits 14, 14′ as shown in FIG. 1, is aligned in the same direction axially to the contact arrangement and, when the contacts 10, 10′ are opened, causes a diffuse arc discharge which is indicated by LB in the figure.

If—in contrast to FIG. 1—the slits 14, 14′ in the two contacts 10, 10′ extend in mutually opposite directions, then a radial magnetic field is created between the contacts 10, 10′ so that an arc discharge, contracted in this case, on the contact plate 15, 15′ is driven out. To this end, the slits in the contact plate may optionally be designed spirally.

In the arrangement shown in FIG. 1, the slitted coil segments lie freely in the outer region and can expand after switching operations. This creates an increased external electric field at the slit edges, which may lead to switching failure particularly when the switching contact arrangement is being used in the high-voltage range.

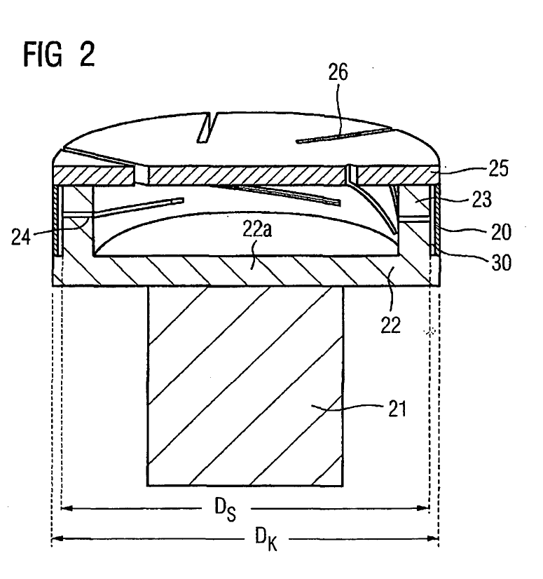

In FIG. 2, the switching contact according to FIG. 1 is modified according to at least one embodiment of the invention. A switching bolt 21, a contact carrier 22 with an annular part 23 as the cup wall and azimuthal slits 24 as well as a contact plate 25 with slits 26 are likewise provided. The cup wall 23 with the coil segments, however, is designed inwardly offset in FIG. 2. A recess is thus formed by the cup wall 23 with diameter Ds together with the base 22a of the contact carrier 22 and the contact plate 25 with respective diameters D_{K}. An annularly circumferential outer support body 20, which encloses at least the coil part of the cup wall 23, is fitted in the recess.

The outer support body 20 consists of steel or similar material with a low electrical conductivity. The support body 20 may also consist of an electrically nonconductive material, for example ceramic. It is also possible to coat a metallic ring on its inside with a ceramic material.

The outer support body 20 must be soldered into the indentation. A solder can thereby penetrate into the slits 24 and thus cause a short circuit or partial short circuit, which leads to a reduction of the magnetic field and therefore to deterioration of the switching properties of the contact.

According to FIG. 2, the outer support body 20 is designed to be so thin and inserted into the recess in such a way that a circumferential cavity 30 remains between the wall of the contact carrier 22 with the coil segments and the support body 20, which produces a “vacuum gap” when the contact arrangement is being used as intended in a vacuum interrupter.

The vacuum gap 30 between the outer support body 20 and the coils segment prevents solder from being able to penetrate into the azimuthal slits 24 or between neighboring slits 24 and the outer support body 20 during the soldering process.

A mechanically firm connection is thus achieved between the outer support body 20 and the other contact parts, without highly conductive short circuits or partial short circuits being able to occur in the coil segments or between coil segments and the outer support body.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A switching contact for vacuum interrupters with at least one of a radial and axial magnetic field, comprising:
a contact carrier containing a coil for generating a magnetic field, formed by azimuthally slitting a wall of a cup-shaped contact carrier;
a contact plate, wherein an outer diameter of the slitted cup wall is less than a diameter of the contact plate lying thereon; and
an annular support body, inserted between the contact plate and a base of the contact carrier, enclosing the contact carrier at least in the slitted region.

2. The switching contact as claimed in claim 1, wherein a free gap exists between an inner wall of the support body and the slitted cup wall.

3. The switching contact as claimed in claim 2, wherein the gap is less than 3 mm.

4. The switching contact as claimed in claim 1, wherein the support body includes a much lower electrical conductivity than the contact carrier with the coil former.

5. The switching contact as claimed in claim 1, wherein the annular support body consists of an iron-based material.

6. The switching contact as claimed in claims 1, wherein the annular support body consists of an electrically nonconductive material, at least on its inside.

7. The switching contact as claimed in claim 6, wherein the electrically nonconductive material is ceramic.

8. The switching contact as claimed in claim 1, wherein the annular support body is soldered to the contact carrier and the contact plate, respectively, only in its upper and lower edge regions.

9. The switching contact as claimed in claim 1, wherein the annular support body has the same outer diameter as the contact plate.

10. The switching contact as claimed in claim 3, wherein the gap is of the order of 1 mm.

11. The switching contact as claimed in claim 2, wherein the annular support body consists of an iron-based material.

12. The switching contact as claimed in claim 2, wherein the annular support body consists of an electrically nonconductive material, at least on its inside.

13. The switching contact as claimed in claim 12, wherein the electrically nonconductive material is ceramic.

14. The switching contact as claimed in claim 2, wherein the annular support body is soldered to the contact carrier and the contact plate, respectively, only in its upper and lower edge regions.

15. The switching contact as claimed in claim 2, wherein the annular support body has the same outer diameter as the contact plate.
